(19) United States
(12) Patent Application Publication
(10) Pub. No.: US 2009/0189079 A1
(43) Pub. Date: Jul. 30, 2009

(54) Radiation conversion device

(75) Inventors: Yasunori Ohta, Yokohama-shi (JP); Eiichi Kito, Minami-ashigara-shi (JP); Naoyuki Nishino, Minami-ashigara-shi (JP); Hiroshi Tamaoki, Odawara-shi (JP); Tatsuo Iiyama, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/320,418

(22) Filed: Jan. 26, 2009

(30) Foreign Application Priority Data
Jan. 29, 2008 (JP) 2008-017291

(51) Int. Cl. G01T 1/20

(52) U.S. Cl. 250/361 R

(57) ABSTRACT

The present invention concerns a radiation conversion device. The radiation conversion device for detecting radiation that has passed through a subject and converting the radiation into image information, is equipped with an information acquisition unit for acquiring condition information concerning a condition of the radiation conversion device, an information storage unit for storing the acquired condition information, and a display unit for displaying the stored condition information.

### BACKGROUND OF THE INVENTION

1. Field of the Invention

The present invention relates to a radiation conversion device for detecting radiation that has passed through a subject and converting the radiation into image information.

2. Description of the Related Art

In the medical field, a radiation image capturing apparatus, in which radiation is applied to a subject, and radiation that has passed through the subject is directed to a radiation conversion device for capturing a radiation image of the subject, has been widely used.

In this case, Japanese Laid-Open Patent Publication No. 2006-208306 discloses a radiation conversion device (electronic cassette) constructed by a plurality of radiation conversion pixels made up from amorphous silicon or the like, which are arranged in a matrix form, wherein the irradiated radiation can be converted directly into electrical signals, or after the radiation has been converted into visible light using a scintillator, the light can be converted into electrical signals and read out. Further, a battery is loaded internally into such a radiation conversion panel, thereby providing a compact structure that can be carried around in a portable manner.

However, when the radiation conversion pixels that make up the radiation conversion device are exposed to radiation over multiple exposure cycles, the characteristics of the pixels (image elements) tend to change and the radiation cannot be converted appropriately into electrical signals, which results in the occurrence of so called pixel defects. If the radiation conversion device is used in such a condition, a desirable radiation image cannot be obtained.

Consequently, a technique exists in which, based on image data that is obtained from each of the radiation conversion pixels, defect information is acquired which indicates the positions of pixel defects, or the number of defects, for thereby issuing a warning depending on necessity. (See, Japanese Laid-Open Patent Publication No. 2000-132662.)

Notwithstanding, in the case of Japanese Laid-Open Patent Publication No. 2000-132662, processing for acquiring the defect information and issuing warnings, etc., is performed by a controller to which the radiation conversion device is connected, and such functions are not provided as part of the radiation conversion device itself. Owing thereto, for example, when the radiation conversion device is used in a state of being separated from the controller, as with a transportable type of radiation conversion device which is driven by a battery, it cannot be confirmed by the radiation conversion device itself whether or not the radiation conversion device has defects therein. Accordingly, there is a concern that a defective radiation conversion device could be used, resulting in the capturing of an inappropriate radiation image.

### SUMMARY OF THE INVENTION

A general object of the present invention is to provide a radiation conversion device, which enables the condition of the radiation conversion device to be confirmed at all times, so that capturing of inappropriate radiation images can be avoided before they occur.

A principal object of the present invention is to provide a radiation conversion device, which enables the condition of a transportable type of radiation conversion device to be confirmed from the radiation conversion device itself.

Another object of the present invention is to provide a radiation conversion device, in which defect information of the radiation conversion pixels constituting the radiation conversion device can be confirmed.

Another object of the present invention is to provide a radiation conversion device in which usage information of the radiation conversion device can be confirmed.

Another object of the present invention is to provide a radiation conversion device in which information pertaining to a cumulative radiation exposure dose of the radiation conversion device can be confirmed.

Another object of the present invention is to provide a radiation conversion device in which information pertaining to a battery charge state of the radiation conversion device can be confirmed.

The radiation conversion device of the present invention, for detecting radiation that has passed through a subject and converting the radiation into image information, is characterized by having an information acquisition unit for acquiring condition information concerning a condition of the radiation conversion device, an information storage unit for storing the acquired condition information, and a display unit for displaying the stored condition information.

According to the present invention, by displaying condition information of the radiation conversion device on a display unit thereof, the usage condition or the presence or absence of defects can be confirmed by means of the radiation conversion device itself. Accordingly, capturing of radiation images using a radiation conversion device, which is in an inappropriate condition, can be avoided before radiation images actually are captured thereby.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an explanatory view of a radiation image capturing system according to an embodiment of the present invention;

FIG. 2 is an interior structural view of an electronic cassette;

FIG. 3 is a schematic block diagram of the circuit structure of a radiation conversion panel making up the electronic cassette; and

FIG. 4 is a schematic block diagram of the radiation image capturing system.

### DESCRIPTION OF THE PREFERRED EMBODIMENTS

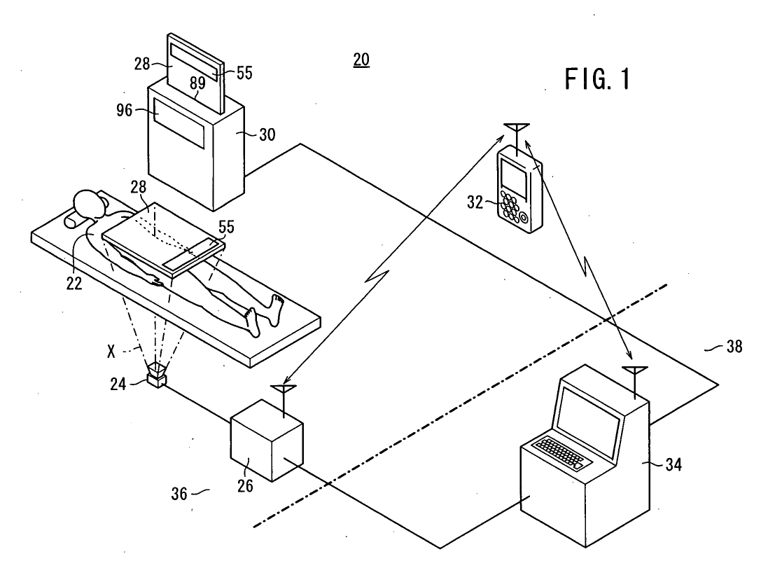

FIG. 1 is an explanatory view showing a radiation image capturing system 20 to which a radiation conversion device of the present invention is applied. The radiation image capturing system 20 is equipped with a radiation source 24 for irradiating a patient 22 (subject) with radiation X having a given dose according to image capturing conditions, a radiation source control device 26 for controlling the radiation source 24, an electronic cassette 28 (radiation conversion device) for converting radiation X that has passed through the patient 22 into radiation image information. The radiation image capturing system 20 further comprises a cradle 30 for performing a charging process on the electronic cassette 28, for performing a process to display patient information and image capturing conditions, and for carrying out a signal transmitting and receiving process of image information based on the radiation X that is detected by the electronic cassette 28, a portable information terminal 32 having an image capturing switch for the radiation source 24, and which is carried by a technician for confirming conditions including image capturing operations, and a console 34, by which the radiation source control device 26, the cradle 30, and the portable information terminal 32 are controlled, while also transmitting and receiving necessary information therebetween.

The patient information is defined as information for specifying a patient 22, such as the name and sex of the patient 22, a patient ID number, and the like. The image capturing conditions are conditions for determining a tube voltage, tube current, irradiation time, etc., for irradiating an imaging location of the patient 22 with an appropriate dose of radiation X. For example, the image capturing conditions may include the imaging location, the image capturing method, and the like. The patient information and the image capturing information can be obtained from the console 34.

The radiation source 24, the radiation source control device 26 and the cradle 30 are arranged inside of an image capturing room 36 where the image is to be captured, whereas the console 34 is disposed in an operations room 38 outside of the image capturing room 36. Further, wireless transmission of necessary information is transmitted and received between the radiation source control device 26 and the portable information terminal 32, as well as between the portable information terminal 32 and the console 34.

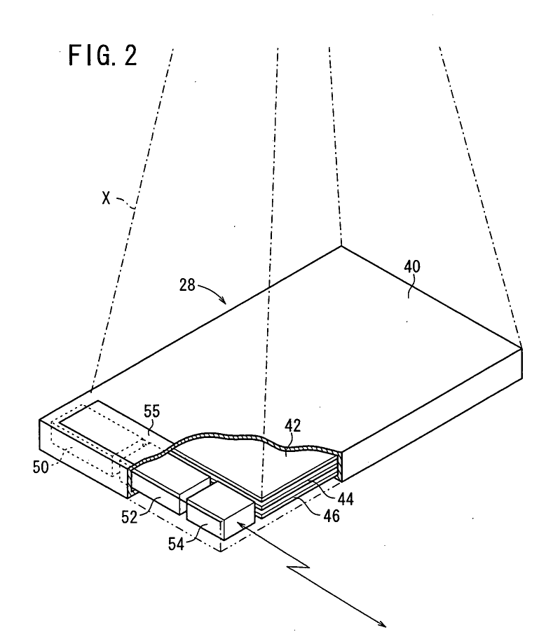

FIG. 2 is an interior structural view of the electronic cassette 28. The electronic cassette 28 is equipped with a casing 40 made from a material which is permeable to radiation X. Inside of the casing 40, a grid 42 for removing scattered radiation X from the patient 22, a radiation conversion panel 44 for detecting radiation X that has passed through the patient 22, and a lead plate 46 for absorbing backscattered radiation X are arranged in this order.

A battery 50 which serves as a power source for the electronic cassette 28, a controller 52 that controls driving of the radiation conversion panel 44 based on the power supplied from the battery 50, and a transceiver (information acquisition unit) 54 for wirelessly transmitting signals to the cradle 30 including information converted into electrical signals from radiation X by the radiation conversion panel 44, are accommodated inside the casing 40. Moreover, in the controller 52 and the transceiver 54, for avoiding damage caused by radiation X, it is preferable for a lead plate or the like to be disposed on surface sides of the casing 40 that are subject to being irradiated with radiation X.

Further, on a surface of the casing 40 corresponding to a region where the battery 50, the controller 52 and the transceiver 54 are arranged, a display unit 55 is disposed, which displays image capturing conditions and patient information of the patient 22 whose image is to be captured by the electronic cassette 28, together with other condition information, such as the number of times that the electronic cassette 28 has been used, a cumulative radiation exposure dose, or the charge state of the battery 50.

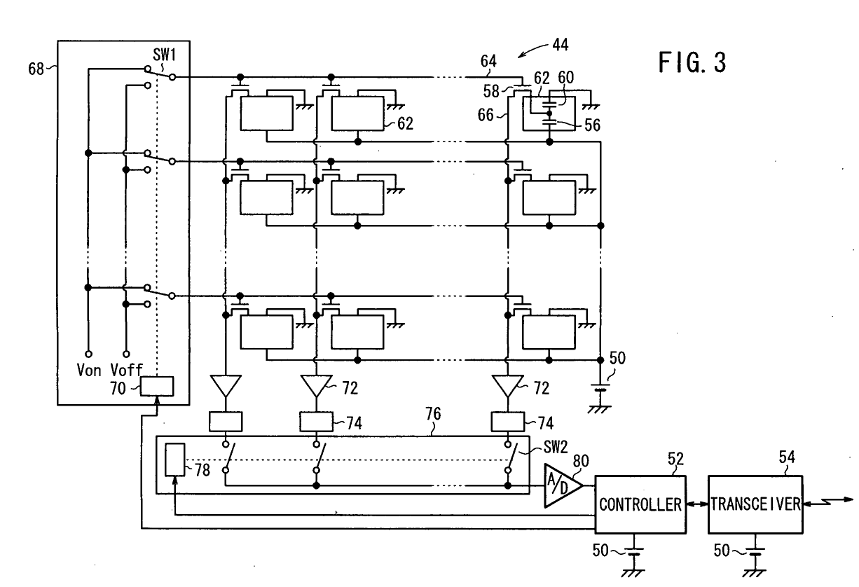

FIG. 3 is a block diagram of a circuit configuration of the electronic cassette 28 including the radiation conversion panel 44 therein. The radiation conversion panel 44 includes a structure in which a photoelectric conversion layer 56 made up from an amorphous selenium (a-Se) material or the like, which generates electric charges upon sensing radiation X, is disposed on thin film transistors (TFTs) 58 arrayed in a matrix form. After the generated electric charges are accumulated in storage capacitors 60, the TFTs 58 are successively turned on one line at a time, and the electric charges are read out as image signals. FIG. 3 shows the connected relationship of only one of the TFTs 58 and one pixel (image element) 62 made up from a photoelectric conversion layer 56 and a storage capacitor 60, whereas the structures of other similar pixels have been omitted from illustration for the sake of simplicity. Since when heated to high temperatures, the structure of amorphous selenium changes and the functionality thereof is lowered, amorphous selenium must be used within a prescribed temperature range. Accordingly, it is preferable to provide some means for cooling the radiation conversion panel 44 inside the electronic cassette 28.

Gate lines 64, which extend in parallel to the direction of the rows, and signal lines 66 which extend in parallel to the direction of the columns, are connected to the TFTs 58, which are connected respectively to each of the pixels 62. Each of the gate lines 64 is connected to a line scanning driver 68, and each of the signal lines 66 is connected to a multiplexer 76 that constitutes a reading circuit.

Control signals Von, Voff that control ON and OFF states of the TFTs 58 arrayed in the direction of the rows, are supplied from the line scanning driver 68 to the gate lines 64. In this case, the line scanning driver 68 comprises a plurality of switches SW1 that switch the gate lines 64 on or off, and an address decoder 70, which outputs selection signals for selecting one of the switches SW1. Address signals are supplied from the controller 52 to the address decoder 70.

Further, the signal lines 66 are supplied with electric charges, which are stored in the storage capacitors 60 of each of the pixels 62, through the TFTs 58 arranged in the columns. The electric charges supplied to the signal lines 66 are amplified by amplifiers 72. The amplifiers 72 are connected through respective sample and hold circuits 74 to the multiplexer 76. The multiplexer 76 comprises a plurality of switches SW2 for successively switching between the signal lines 66, and an address decoder 78 for outputting a selection signal for selecting one of the switches SW2 at a time. The address decoder 78 is supplied with an address signal from the controller 52. An A/D converter 80 is connected to the multiplexer 76. A radiation image signal is converted by the A/D converter 80 into a digital image signal representing the radiation image information, which is supplied to the controller 52.

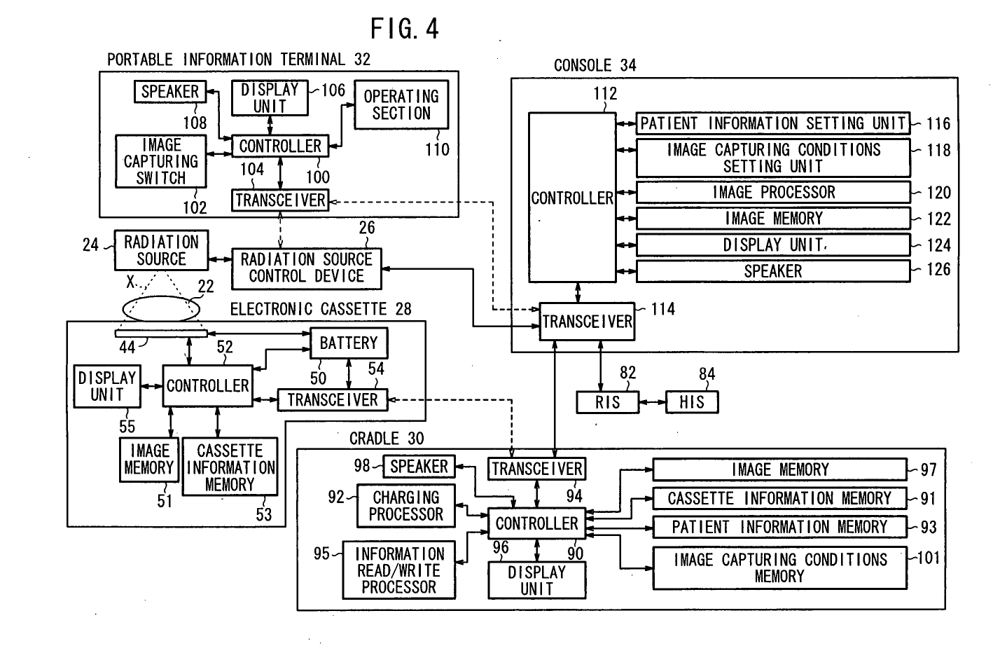

FIG. 4 is a schematic block diagram of the radiation image capturing system 20.

The radiation conversion panel 44, an image memory 51 for storing radiation image information detected by the radiation conversion panel 44, a cassette information memory (information storing unit) 53 for storing cassette information comprising information specific to the electronic cassette 28, a display unit 55 for displaying cassette information, a transceiver 54, and a battery 50 that supplies power to the electronic cassette 28, are connected respectively to the controller 52 of the electronic cassette 28.

Herein, the cassette information may be defined to include, for example, a number of usage times at which radiation image information has been recorded with respect to the electronic cassette 28, a cumulative exposure dose of radiation X to which the electronic cassette 28 has been exposed, defect information, which is detected based on the radiation image information obtained from each of the pixels (image elements) 62 that make up the radiation conversion panel 44, condition information of the charge state etc. of the battery 50, and patient information associated with the radiation image information stored in the image memory 51. The condition information can be generated by the controller 52 (information acquisition unit), or alternatively, can be generated by the cradle 30 or the console 34 and imported from the transceiver 54 (information acquisition unit).

To a controller 90 of the cradle 30, there are connected respectively, a charging processor 92 that carries out a charging process on the battery 50 in the electronic cassette 28 accommodated therein, a cassette information memory 91 for storing cassette information obtained from the electronic cassette 28, a patient information memory 93 and an image capturing condition memory 101 that store patient information and image capturing conditions obtained from the console 34, an information read/write processor 95 that writes in patient information or image capturing conditions to the electronic cassette 28 and also reads out radiation image information from the electronic cassette 28, an image memory 97 that stores the read out radiation image information, a display unit 96 for displaying necessary information including patient information, image capturing conditions and acquired radiation image information, a speaker 98 for notifying a technician or the like concerning required information, and a transceiver (signal transmitting/receiving unit) 94 for carrying out transmission and reception of information between the electronic cassette 28 and the console 34. The transceiver 94 performs transmission and reception of signals by means of wireless communications. Further, the charging process carried out with respect to the battery 50 of the electronic cassette 28 can be performed in a non-contact state through the transceiver 94, or in a contact state through a non-illustrated connector provided on the electronic cassette 28 loaded into the cradle 30.

The controller 100 of the portable information terminal 32 supplies an image capturing signal generated by the image capturing switch 102 that drives the radiation source 24 to the radiation source control device 26 through a transceiver (signal transmitting/receiving unit) 104. Further, the controller 100 displays on the display unit 106 patient information, imaging capturing conditions, and the like, which are received from the console 34 through the transceiver 104, and also carries out processing for notifying a technician or the like by causing necessary information to be emitted from a speaker 108. The portable information terminal 32 includes an operating section 110 by which necessary information can be set therein.

The console 34 is equipped with a controller 112, a transceiver (signal transmitting/receiving unit) 114 for transmitting and receiving necessary information via wireless communications with respect to the radiation source control device 26, the cradle 30 and the portable information terminal 32, a patient information setting unit 116 for setting patient information, an image capturing conditions setting unit 118 for setting required image capturing conditions for an image to be captured by the radiation source control device 26, an image processor 120 for performing image processing on the radiation image information supplied from the electronic cassette 28 via the cradle 30, an image memory 122 for storing the processed radiation image information, a display unit 124 for displaying radiation image information and other necessary information, and a speaker 126 for notifying a technician or the like concerning the necessary information.

The console 34 is connected to a radiology information system (RIS) 82, which generally manages radiation image information handled by the radiological department of a hospital along with other information. The RIS 82 is connected to a hospital information system (HIS) 84, which generally manages medical information in the hospital. Image capturing order information, including the patient information and the image capturing conditions, may be set directly by the console 34, or alternatively, can be supplied to the console 34 from an external location via the RIS 82.

The radiation image capturing system 20 according to the present embodiment is constructed basically as described above. Next, explanations shall be made concerning operations of the radiation image capturing system 20.

When a radiation image is to be captured of the patient 22, using the patient information setting unit 116 of the console 34, patient information concerning the patient 22 is set, together with setting required image capturing conditions using the image capturing conditions setting unit 118. Such information may be obtained from the RIS 82 and the HIS 84 from an upstream location via the transceiver 114. The thus set patient information and image capturing conditions can be displayed for confirmation on the display unit 124.

Next, the set patient information and image capturing conditions are transmitted from the transceiver 114 to the cradle 30, which is arranged inside the image capturing room 36, and the information is displayed on the display unit 96 by the controller 90 of the cradle 30. In this case, the technician confirms the name etc. of the patient 22, whose image is to be captured, according to the patient information displayed on the display unit 96. By means of this confirmation process, accidents such as capturing an image by mistake of the wrong patient can be prevented from occurring. Further, according to the displayed image capturing conditions, the technician can confirm the imaging location, the image capturing method, etc.

On the other hand, the electronic cassette 28 used for capturing images is loaded into the cradle 30, and a charging process on the battery 50 is carried out by the charging processor 92. The information read/write processor 95 transmits, to the electronic cassette 28 through the transceiver 94, image capturing conditions and patient information pertaining to the patient 22 whose image is to be captured. The controller 52 of the electronic cassette 28 stores the transmitted patient information and image capturing conditions, in the cassette information memory 53, together with displaying such information and conditions on the display unit 55. Moreover, as mentioned later, the condition information of the electronic cassette 28 itself also is displayed on the display unit 55.

Further, the patient information and the image capturing conditions are transmitted from the transceiver 114 of the console 34 to the portable information terminal 32, which is carried by the technician, by means of wireless communications, and the information is displayed on the display unit 106. In this case, the technician can confirm the patient information and the image capturing conditions that are displayed on the display unit 106 of the portable information terminal 32, so that desired preparations for capturing the image can be carried out.

Furthermore, the image capturing conditions are transmitted to the radiation source control device 26. The radiation source control device 26 sets the radiation X tube voltage, the tube current, and the irradiation time, which make up image capturing conditions, in the radiation source 24, thus carrying out preparations for capturing an image.

A technician confirms the patient information and the condition information of the electronic cassette 28, as displayed on the display unit 96 of the cradle 30 or on the display unit 55 of the electronic cassette 28. The electronic cassette 28 in which the charging process has been completed and for which condition information is displayed indicating that the cassette is usable, is taken out from the cradle 30, and then in accordance with the designated image capturing conditions, the electronic cassette 28 is set at a desired image capturing location on the patient 22. In this case, in accordance with the displayed information on the display unit 55 of the electronic cassette 28, the technician can reliably carry the electronic cassette 28 to a suitable patient 22, and set the electronic cassette 28 at a desired imaging capturing location.

After the electronic cassette 28 has been set in an appropriate condition with respect to the patient 22, the technician operates the image capturing switch 102 of the portable information terminal 32, whereupon capturing of the radiation image is carried out. When the image capturing switch 102 is operated, the controller 100 of the portable information terminal 32 transmits an image capturing initiation signal to the radiation source control device 26 via the transceiver 104. The radiation source control device 26 that has received the image capture initiation signal controls the radiation source 24 according to the image capturing conditions supplied beforehand from the console 34, and thereby irradiates the patient 22 with radiation X.

Radiation X that has passed through the patient 22, after scattered rays have been removed by the grid 42 of the electronic cassette 28, irradiate the radiation conversion panel 44 and are converted into electric signals by the photoelectric conversion layer 56 of each of the pixels 62 making up the radiation conversion panel 44, which are retained as charges in the storage capacitors 60 (see FIG. 3). Next, the electric charge information that forms the radiation image information of the patient 22 stored in each of the storage capacitors 60 is read out in accordance with address signals, which are supplied from the controller 52 to the line scanning driver 68 and the multiplexer 76.

More specifically, the address decoder 70 of the line scanning driver 68 outputs a selection signal based on the address signal supplied from the controller 52, thereby selecting one of the switches SW1, and supplies a control signal Von to the gate of the TFT 58 that is connected to a corresponding gate line 64. On the other hand, the address decoder 78 of the multiplexer 76 outputs a selection signal according to the address signal supplied from the controller 52, and successively switches the switch SW2, whereby the radiation image information, which is formed as electric charge information stored in the storage capacitors 60 of each of the pixels (image elements) 62 that are connected to the gate line 64 selected by the line scanning driver 68, is read out in succession through the signal lines 66.

The radiation image information read from the storage capacitors 60 of the pixels 62 connected to the selected gate line 64 of the radiation conversion panel 44 are amplified by respective amplifiers 72, sampled by the sample and hold circuits 74, and are supplied to the A/D converter 80 through the multiplexer 76 and converted into digital signals. The radiation image information having been converted into digital signals is temporarily stored in the image memory 51 connected to the controller 52.

Similarly, the address decoder 70 of the line scanning driver 68 successively turns on the switches SW1 according to the address signals supplied from the controller 52, and reads out the radiation image information, which is made up of charge information stored in the storage capacitors 60 of each of the pixels 62 connected respectively to the gate lines 64 through the signal lines 66, whereupon the radiation image information is temporarily stored in the image memory 51 connected to the controller 52 through the multiplexer 76 and the A/D converter 80.

Further, at a point in time when image capturing is completed, the controller 52 of the electronic cassette 28 records as cassette information in the cassette information memory 53, the number of usage times of the electronic cassette 28, i.e., a count of the number of times the electronic cassette 28 has been exposed to radiation X. Further, based on the radiation image information stored in the image memory 51, the controller 52 calculates a cumulative radiation X exposure dose, from initiation of use of the electronic cassette 28 to the present time, for each of the pixels 62 of the radiation conversion panel 44, or as an averaged value of the cumulative radiation exposure dose from each of the pixels 62, and records the calculated dose in the cassette information memory 53.

Furthermore, based on the radiation image information stored in the image memory 51, the controller 52 calculates defect information, in accordance with the presence or absence of defective pixels, the degree of such defects, the positions of such defects or the like, for example, by comparing the radiation image information between adjacent pixels 62, and records such defect information in the cassette information memory 53. As methods for detecting defective pixels, for example, a method utilizing dark pixels (dark current), and a method utilizing radiation image information obtained by uniformly irradiating (exposing) the electronic cassette 28 to radiation X of a preset dose in a state where the patient 22 is not disposed, may be considered. Apart from these methods, other detection methods for detecting defective pixels, which are implemented by various types of radiation image capturing apparatuses, can also be used. (Refer to Japanese Laid-Open Patent Publication No. 2008-245049.)

Upon completion of image capturing, the electronic cassette 28 in which radiation image information of the patient 22 has been recorded is loaded into the cradle 30, which is arranged inside of the image capturing room 36. A charging process is carried out on the battery 50 by the charging processor 92, and together therewith, a process for reading out the radiation image information and the cassette information is performed by the information read/write processor 95.

More specifically, the information read/write processor 95, which reads information of the cradle 30, reads out the radiation image information stored in the image memory 51 of the electronic cassette 28 and stores such information in the image memory 97, and also reads out the cassette information stored in the cassette information memory 53 of the electronic cassette 28, while storing such information in the cassette information memory 91 and the patient information memory 93. The information also is displayed on the display unit 96 by the controller 90. For example, by displaying as a preview image on the display unit 96 the radiation image information read out from the image memory 97, along with displaying the patient information read out from the cassette information memory 53 of the display unit 96, whether or not appropriate image capturing was carried out with respect to a desired patient 22 can be confirmed inside the image capturing room 36. Further, by displaying the positions of defects, the number of usage times of the electronic cassette 28, the cumulative exposure dose, and defect information from the radiation conversion panel 44, etc., as read out from the cassette information memory 53 of the display unit 96, whether or not the electronic cassette 28 is in an appropriate usage condition can be confirmed.

Further, on the display unit 55 of the electronic cassette 28 that is loaded in the cradle 30, electronic cassette 28 condition information, which is read out from the cassette information memory 53 of the electronic cassette 28, and more specifically condition information, such as positions of defects, usage times, the cumulative radiation exposure dose, and the charge state of the battery 50, etc., of the electronic cassette 28 are displayed. Based on such displayed condition information, a technician can reliably judge whether the electronic cassette 28 is usable or not. Accordingly, selecting an unsuitable electronic cassette 28 and erroneous capturing of radiation images therewith can be prevented before such an event happens. Further, because the positions of defects in the electronic cassette 28 can be determined visually at a stage before the image is captured, for example, by performing image capturing while removing regions where defects are densely packed, from the image capturing region, even with an electronic cassette 28 which has deteriorated to a certain degree, radiation images still can be obtained which do not form an obstacle to effective diagnosis.

On the other hand, the radiation image information stored in the image memory 97 of the cradle 30, together with the patient information stored in the patient information memory 93, are transmitted to the console 34 via the transceiver 94. At the console 34, after image processing has been implemented with respect to the radiation image information by the image processor 120, the radiation image information, in a state of association with the patient information, is stored in the image memory 122. Thereafter, by displaying the radiation image information stored in the image memory 122 on the display unit 124, a final confirmation of the image can be carried out.

After compression processing is implemented, as may be needed, on the radiation image information that has been transmitted to the console 34, the radiation image information may be transmitted from the transceiver 114 to the portable information terminal 32 held by the technician, so as to provide a preview image on the display unit 106. Further, a configuration can also be provided in which the radiation image information is transmitted directly to the portable information terminal 32 from the cradle 30 or the electronic cassette 28.

Of course, the present invention is not limited to the above-described embodiment, and the invention can be freely modified, within a range that does not deviate from the essence and gist of the present invention.

For example, the radiation conversion panel 44 accommodated in the electronic cassette 28 converts the radiation dose of the irradiated radiation X directly into electric signals through the photoelectric conversion layer 56. However, in place of this structure, a radiation conversion panel in which irradiated radiation X is converted initially into visible light by a scintillator, and thereafter, the visible light is converted into electric signals using a solid-state detector element formed from amorphous silicon (a-Si) or the like, may also be used (see, Japanese Patent No. 3494683).

Further, the radiation image information can be obtained using a radiation conversion panel of a light-conversion type. With such a light-conversion type of radiation conversion panel, radiation is irradiated onto respective solid state detection elements arranged in a matrix form, and an electrostatic latent image corresponding to the irradiation dose is stored cumulatively in the solid state detection elements. When the electrostatic latent image is read, reading light is irradiated onto the radiation conversion panel, and the generated current values are acquired as radiation image information. Further, by irradiating the radiation conversion panel with erasing light, the radiation image information in the form of a residual electrostatic latent image can be erased and the radiation conversion panel can be reused (see, Japanese Laid-Open Patent Publication No. 2000-105297).

What is claimed is:

1. A radiation conversion device for detecting radiation that has passed through a subject and converting the radiation into image information, comprising:
an information acquisition unit for acquiring condition information concerning a condition of the radiation conversion device;
an information storage unit for storing the acquired condition information; and
a display unit for displaying the stored condition information.

2. The radiation conversion device according to claim 1, wherein the condition information comprises information indicating defect positions of a plurality of radiation conversion pixels that convert the radiation into image information.

3. The radiation conversion device according to claim 1, wherein the condition information comprises information concerning the number of times of the radiation conversion device has been used.

4. The radiation conversion device according to claim 1, wherein the condition information comprises information concerning a cumulative radiation exposure dose of the radiation with respect to the radiation conversion device.

5. The radiation conversion device according to claim 1, wherein the condition information comprises information indicative of a charge state of the radiation conversion device.

6. The radiation conversion device according to claim 1, wherein the information acquisition unit acquires the condition information from an external device of the radiation conversion device.

7. The radiation conversion device according to claim 1, wherein the radiation conversion device is a portable structure in which a battery is mounted.

8. The radiation conversion device according to claim 7, wherein the information acquisition unit acquires the condition information from a cradle in which the radiation conversion device is mounted for charging the battery.
